(19) United States
(12) Patent Application Publication
(10) Pub. No.: US 2019/0129672 A1
(43) Pub. Date: May 2, 2019

(54) INFORMATION PROCESSING PROGRAM, INFORMATION PROCESSING METHOD, AND INFORMATION PROCESSING TERMINAL

(71) Applicant: LINE Corporation, Tokyo (JP)

(72) Inventors: Hiroaki Arisada, Tokyo (JP); Hideyuki Ikeda, Tokyo (JP); Masahiro Minagawa, Tokyo (JP); Kyungbeom Kim, Tokyo (JP)

(73) Assignee: LINE Corporation, Tokyo (JP)

(21) Appl. No.: 16/170,770

(22) Filed: Oct. 25, 2018

(30) Foreign Application Priority Data
Oct. 26, 2017 (JP) 2017-207560

(51) Int. Cl. G06F 3/14; G06Q 10/02

(52) U.S. Cl. CPC G06F 3/14; G06F 3/0484; G06Q 10/02

(57) ABSTRACT

An information processing program causes a terminal to execute: acquiring ticket data; displaying an electronic ticket associated with the ticket data and an operation status showing an operation state of the electronic ticket; allowing the information processing terminal to receive an operation for changing the operation status of the electronic ticket if a predetermined condition corresponding to the ticket data is satisfied; allowing the information processing terminal to change the operation status of the electronic ticket to an operated state in response to an operation of a user changing the operation status; and transmitting a usage status change request for changing a usage status of the ticket data after the operation status of the electronic ticket is changed. The usage status of the electronic ticket is not changed if the operation status of the electronic ticket is the operated state and the usage status change request is not transmitted.

### BACKGROUND I/F THE DISCLOSURE

### 1. Field of the Disclosure

The present disclosure relates to an information processing program, an information processing method, and an information processing terminal for displaying a ticket.

### 2. Description of Related Art

A technique has been developed in recent years to display a ticket for participating in an event as an electronic ticket on an information processing terminal of a user who purchases the ticket. Japanese Unexamined Patent Application Publication No. 2014-096137 discloses a technique in which ticket data is downloaded to an information processing terminal such as a smartphone by purchasing a ticket by a user. In the technique described in JP 2014-096137 A, the ticket data downloaded to the information processing terminal such as a smartphone is displayed on the screen, a predetermined input instruction is detected on condition that a predetermined operation is detected on the screen, and the status data indicating the use history of the ticket data is updated on condition that the predetermined input instruction is detected. JP 2014-096137 A discloses that the ticket data can be used even in a situation where the information processing terminal such as a smartphone cannot communicate with a server.

As described above, in the technique described in JP 2014-096137 A, the status data indicating the use history of the ticket data is updated by the information processing terminal such as a smartphone. This causes the server to fail to centrally manage the status data, which may cause problems such as unauthorized use of ticket data by tampering with the status data.

The present disclosure has been made in view of the above problems, and it is an object of the present disclosure to provide an information processing program, information processing method and information processing terminal enabling entry processing even in a poor communication environment and a central management of status data by a server.

### SUMMARY I/F THE DISCLOSURE

An information processing program according to an embodiment of the present disclosure causes an information processing terminal to execute the steps of: acquiring ticket data; displaying an electronic ticket associated with the ticket data and an operation status showing an operation state of the electronic ticket; allowing the information processing terminal to receive an operation for changing the operation status of the electronic ticket if a predetermined condition corresponding to the ticket data is satisfied; allowing the information processing terminal to change the operation status of the electronic ticket to an operated state in response to an operation of a user changing the operation status; and transmitting a usage status change request for changing a usage status of the ticket data after the operation status of the electronic ticket is changed. The usage status of the electronic ticket is not changed if the operation status of the electronic ticket is the operated state and the usage status change request is not transmitted.

The information processing program according to an embodiment of the present disclosure may further cause the information processing terminal to execute the step of retrying transmission of the usage status change request at predetermined time intervals if the usage status change request is not transmitted.

The information processing program according to an embodiment of the present disclosure may further cause the information processing terminal to execute the step of retrying transmission of the usage status change request a predetermined number of times if the status change request is not transmitted.

In the information processing program according to an embodiment of the present disclosure, the predetermined condition may be whether a current time is within a predetermined time period corresponding to the ticket data.

The information processing program according to an embodiment of the present disclosure may further cause the information processing terminal to execute the steps of: determining whether or not communication is possible before transmitting the usage status change request; and transmitting the usage status change request if a result of the determination is in that the communication is possible.

The information processing program according to an embodiment of the present disclosure may further cause the information processing terminal to execute the step of displaying the electronic ticket and an object corresponding to the electronic ticket. A first object associated with a first electronic ticket corresponding to a first event and a second object associated with a second electronic ticket corresponding to a second event may be different from each other.

In the information processing program according to an embodiment of the present disclosure, the object may include an object that dynamically changes in response to an operation of the user.

In the information processing program according to an embodiment of the present disclosure, the object may be a background.

The information processing program according to an embodiment of the present disclosure may further cause the information processing terminal to execute the step of notifying that the change of the operation status cannot be canceled before the operation status of the electronic ticket in the operated state is displayed and after the operation status of the electronic ticket is displayed in an unoperated state.

In the information processing program according to an embodiment of the present disclosure, the operation status of the electronic ticket need not be allowed to be changed to an unoperated state after the operation status of the electronic ticket is displayed in the operated state.

In the information processing program according to an embodiment of the present disclosure, the operation status of the electronic ticket may be displayed in an unoperated state in response to acceptance of a predetermined operation after the operation status of the electronic ticket is displayed in the operated state.

In the information processing program according to an embodiment of the present disclosure, the predetermined operation may be associated with the ticket data in advance.

In the information processing program according to an embodiment of the present disclosure, the predetermined operation may be one of an operation input to a screen of the information processing terminal, a voice input, and a character input.

An information processing method according to an embodiment of the present disclosure includes the steps of: acquiring ticket data; displaying an electronic ticket associated with the ticket data and an operation status showing an operation state of the electronic ticket; allowing an acceptance of an operation for changing the operation status of the electronic ticket if a predetermined condition corresponding to the ticket data is satisfied; changing the operation status of the electronic ticket to an operated state in response to the operation for changing the operation status by the user; and transmitting a usage status change request for changing a usage status of the ticket data after the operation status of the electronic ticket is changed. The usage status of the electronic ticket is not changed if the operation status of the electronic ticket is the operated state and the usage status change request is not transmitted.

A request information processing terminal according to an embodiment of the present disclosure includes: an acquiring processor for acquiring ticket data; a display processor for displaying an electronic ticket associated with the ticket data and an operation status showing an operation state of the electronic ticket; an acceptance processor for allowing an acceptance of an operation for changing the operation status of the electronic ticket if a predetermined condition corresponding to the ticket data is satisfied; and a transmission processor for changing the operation status of the electronic ticket to an operated state in response to the operation for changing the operation status by the user. The transmission processor transmits a usage status change request for changing a usage status of the ticket data after the operation status of the electronic ticket is changed. The usage status of the electronic ticket is not changed if the operation status of the electronic ticket is the operated state and the usage status change request is not transmitted.

### BRIEF DESCRIPTION I/F THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a configuration of a communication system according to a form of an embodiment,

FIG. 2 is a diagram illustrating a list of electronic tickets displayed on a terminal according to a form of an embodiment,

FIG. 3 is a diagram illustrating an example of an electronic ticket displayed on a terminal according to a form of an embodiment,

FIG. 4 is a diagram illustrating another example of an electronic ticket displayed on the terminal according to a form of an embodiment,

FIG. 5 is a diagram illustrating yet another example of an electronic ticket displayed on the terminal according to a form of an embodiment,

FIG. 6 is a diagram illustrating yet another example of an electronic ticket displayed on the terminal according to a form of an embodiment,

FIG. 7 is a diagram illustrating information on ticket data according to a form of an embodiment,

FIG. 8 is a diagram illustrating an example of a sequence of a process of a communication system according to a form of an embodiment, and

FIG. 9 is a flowchart illustrating an example of a process of a terminal according to a form of an embodiment.

### DETAILED DESCRIPTION I/F EMBODIMENTS

<Compliance of Legal Matters>

Note that when embodying the disclosure described in this specification, it will be embodied in compliance with the legal matters of the embodying country related to the embodiments of the present disclosure.

Embodiments for embodying an information processing program, an information processing method, and an information processing terminal according to the present disclosure will be described with reference to the drawings.

<System Configurations>

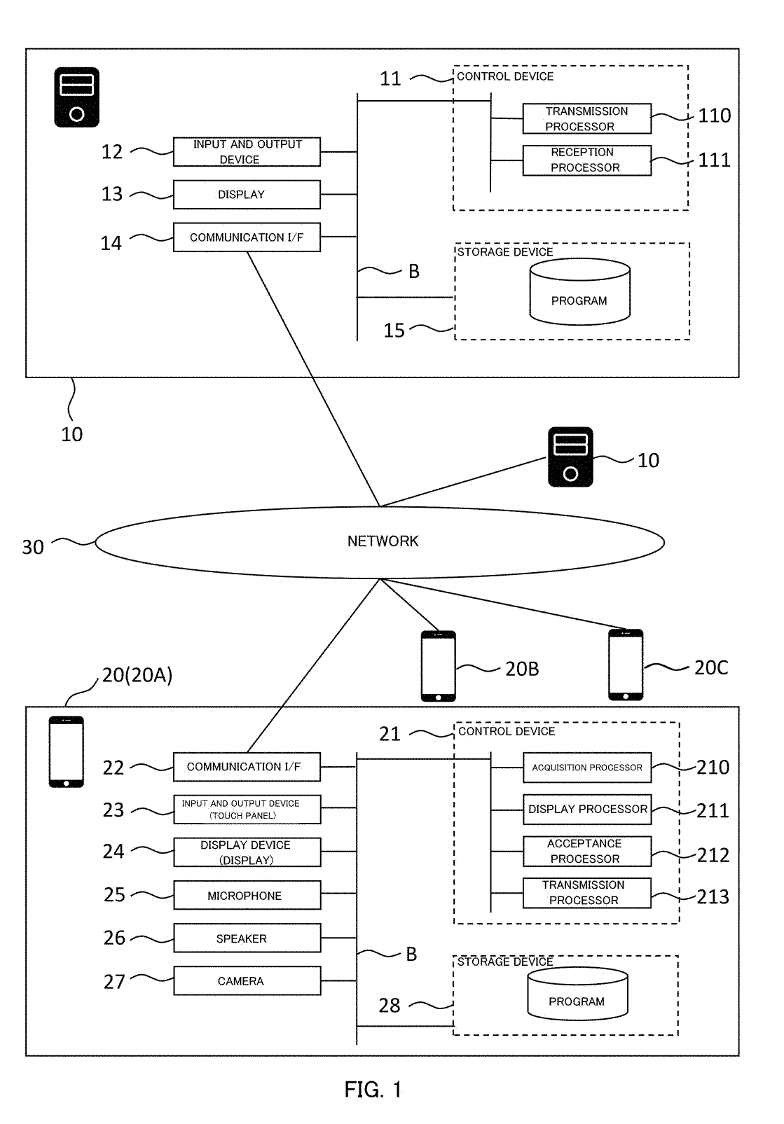

FIG. 1 shows a configuration of a communication system according to an embodiment of the present disclosure. As disclosed in FIG. 1, in the communication system, a server 10 and terminals 20 (a terminal 20A, a terminal 20B, and a terminal 20C) are connected via a network 30. The server 10 provides the terminals 20 owned by users with a service for embodying transmission and reception of messages between the terminals 20 via the network 30. Note that the number of the terminals 20 connected to the network 30 is not limited.

The network 30 serves to connect one or more terminals 20 and one or more servers 10. That is, the network 30 corresponds to a communication network that provides a connection path that allows the terminals 20 and servers 10 to transmit and receive data after the terminals 20 are connected to the servers 10.

One or more portions of the network 30 may be a wired network or a wireless network. The network 30 may be, for example but not limited to, an ad hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of a public switched telephone network (PSTN), a mobile telephone network, integrated service digital networks (ISDNs), wireless LANs, long term evolution (LTE), code division multiple access (CDMA), Bluetooth (registered trademark), and satellite communication, or a combination of two or more of these. The network 30 may include one or more networks 30.

The terminal 20 (terminal 20A, terminal 20B, and terminal 20C) may be any terminal as long as it is an information processing terminal capable of embodying the functions described in the embodiments. The terminal 20 may include, for example but not limited to, a smart phone, a mobile phone (a feature phone), a computer (such as but not limited to a desktop, a laptop, and a tablet), a media computer platform (such as but not limited to a cable set top box, a satellite set top box, and a digital video recorder), a hand-held computer device (such as but not limited to a personal digital assistant (PDA), and an e-mail client), a wearable terminal (such as a glasses type device, and a watch type device), or other types of computers, or a communication platform. Also, the terminal 20 may be referred to as an information processing terminal.

Since the configurations of the terminal 20A, the terminal 20B and the terminal 20C are basically the same, the terminal 20 will be described in the following description. Further, if needed, the user information associated with the terminal 20X is described as user information X, and the user that operates the terminal 20X is described as user X. The user information is part or all of information associated with an account in social networking service (SNS) typified by instant messenger. The user information may include, for example but not limited to, a user name, a user image, an age of a user, a gender of a user, an address of a user, interests preference of a user input by a user, and information that identifies the user, such as a user identifier set by the SNS system, or may be any one or a combination thereof.

The server 10 includes a function of providing a predetermined service to the terminal 20. The server 10 may be any type of information processing apparatus as long as it is capable of embodying the functions described in the embodiments. The server 10 may include, for example but not limited to, a server device, a computer (such as but not limited to a desktop, a laptop, and a tablet), a media computer platform (such as but not limited to a cable set top box, a satellite set top box, and a digital video recorder), a handheld computing device (such as but not limited to a PDA, and an e-mail client), or another type of computer, or a communication platform. Further, the server 10 may be referred to as an information processing apparatus.

<Hardware (HW) Configuration>

With reference to FIG. 1, the HW configuration of each device included in the communication system will be described.

(1) HW Configuration of Terminal

The terminal 20 includes a control device 21 (central processing unit (CPU)), a storage device 28, a communication interface (I/F) 22, an input and output device 23, a display device 24, a microphone 25, a speaker 26, and a camera 27. The components of the HW of the terminal 20 are, for example, connected to each other via a bus B although the components are not limited to the example.

The communication I/F 22 exchanges various data via the network 30. The communication may be performed by either wired or wireless, and any communication protocol may be used as long as mutual communication can be performed. The communication I/F 22 has a function of communicating with the server 10 via the network 30. The communication I/F 22 transmits various data to the server 10 in accordance with instructions from the control device 21. Further, the communication I/F 22 receives various data transmitted from the server 10 and transmits the data to the control device 21.

The input and output device 23 includes a device for inputting various operations to the terminal 20 and a device for outputting processing results processed by the terminal 20. In the input and output device 23, the input device and the output device may be integrated, or the input device and the output device may be separated.

The input device is embodied by any one or a combination of all types of devices capable of receiving input from the user and transmitting the information on the input to the control device 21. The input device may include, for example but not limited to, hardware keys such as a touch panel, a touch display, and a keyboard, a pointing device such as a mouse, a camera (operation input through a moving image), and a microphone (operation input via voice).

The output device is embodied by any one or combination of all types of devices capable of outputting the processing result processed by the control device 21. The output device may include, for example but not limited to, a touch panel, a touch display, a speaker (audio output), a lens (such as but not limited to three dimensions (3D) output and a hologram output), and a printer.

The display device 24 is embodied by any one or combination of all types of devices capable of displaying according to the display data written in the frame buffer. The display device 24 may include, for example but not limited to, a touch panel, a touch display, a monitor (such as but not limited to a liquid crystal display, and an organic electroluminescence display (OELD)), a head mounted display (HDM), a projection mapping, a hologram, and a device capable of displaying images and text information, for example. in the air (that may be a vacuum). Note that these display devices 24 may be capable of displaying the display data in 3D.

In the case where the input and output device 23 is a touch panel, the input and output device 23 and the display device 24 may be arranged to face each other with substantially the same size and shape.

The control device 21 has circuits physically structured to execute functions embodied by codes or instructions included in the program, and is embodied by, for example but not limited to, a data processing apparatus built in the hardware.

The control device 21 may include, for example but not limited to, a central processing unit (CPU), a microprocessor, a processor core, a multiprocessor, an application-specific integrated circuit (ASIC), and a field programmable gate array (FPGA).

The storage device 28 includes a function of storing various programs and various data needed for operating the terminal 20. The storage device 28 may include various storage media such as but not limited to a hard disk drive (HDD), a solid state drive (SSD), a flash memory, a random access memory (RAM), and a read only memory (ROM).

The terminal 20 stores a program P in the storage device 28, and executes the program P so that the control device 21 executes processing as each unit included in the control device 21. That is, the program P stored in the storage device 28 causes the terminal 20 to embody the functions executed by the control device 21.

The microphone 25 is used for inputting voice data. The speaker 26 is used for outputting the voice data. The camera 27 is used for acquiring moving image data.

(2) Server HW Configuration

The server 10 includes a control device 11 (CPU), a storage device 15, a communication interface (I/F) 14, an input and output device 12, and a display 13. The components of the HW of the server 10 are connected to each other via the bus B, for example, although the components are not limited to the example.

The control device 11 has circuits physically structured to execute functions embodied by codes or instructions included in the program, and is embodied by, for example but not limited to, a data processing apparatus built in the hardware.

The control device 11 is typically a central processing unit (CPU), and may be a microprocessor, a processor core, a multiprocessor, an ASIC, or an FPGA otherwise. However, in the present disclosure, the control device 11 is not limited thereto.

The storage device 15 includes a function of storing various programs and various data needed for operating the server 10. The storage device 15 is embodied by various storage media such as HDD, SSD, and flash memory, for example. However, in the present disclosure, the storage device 15 is not limited thereto.

The communication I/F 14 exchanges various data via the network 30. The communication may be performed by either wired or wireless, and any communication protocol may be used as long as mutual communication can be performed. The communication I/F 14 has a function of communicating with the terminal 20 via the network 30. The communication I/F 14 transmits various data to the terminal 20 in accordance with instructions from the control device 11. Further, the communication I/F 14 receives various data transmitted from the terminal 20 and transmits the data to the control device 11.

The input and output device 12 is embodied by a device for inputting various operations to the server 10. The input and output device 12 is embodied by any one or a combination of all types of devices capable of receiving input from the user and transmitting the information on the input to the control device 11. Typically, the input and output device 12 is embodied by hardware keys typified by a keyboard, for example, and pointing devices such as a mouse. Note that the input and output device 12 may include, for example but not limited to, a touch panel, a camera (operation input via a moving image), and a microphone (operation input by voice). However, in the present disclosure, the input and output device 12 is not limited thereto.

The display 13 is typically embodied by a monitor (such as but not limited to liquid crystal display or an organic electroluminescence display (OELD)). The display 13 may be a head mounted display (HDM), for example. Note that the display 13 may be capable of displaying the display data in 3D. However, in the present disclosure, the display 13 is not limited thereto.

The server 10 stores a program P in the storage device 15, and executes the program P so that the control device 11 executes processing as each unit included in the control device 11. That is, the program P stored in the storage device 15 causes the server 10 to embody the functions executed by the control device 11.

In the embodiments of the present disclosure, a description is given by assuming that the CPU of the terminal 20 and/or the server 10 executes the program P to embody the embodiments.

Note that the control device 21 of the terminal 20 and/or the control device 11 of the server 10 may embody the processes not only by the CPU but also by a logic circuit (hardware) provided in an integrated circuit (integrated circuit (IC) chip, and large scale integration (LSI)) and a dedicated circuit. In addition, the circuits may be embodied by one or a plurality of integrated circuits, and a plurality of processes described in the embodiments may be embodied by a single integrated circuit. In addition, the LSI may also be referred to as VLSI, Super LSI, and Ultra LSI, for example, depending on the degree of integration.

In addition, the program P (software program/computer program) of the embodiments of the present disclosure may be provided in a state stored in a computer readable storage medium. The storage medium can store the program in “non-temporary tangible medium.”

The storage medium may include, where appropriate, one or more semiconductor-based or other integrated circuits (IC) (such as but not limited to a field programmable gate array (FPGA) or an application specific integrated circuit (ASIC)), a hard disk drive (HDD), a hybrid hard drive (HHD), an optical disk, an optical disk drive (ODD), a magneto optical disk, a magneto-optical drive, a floppy diskette, a floppy disk drive (FDD), a magnetic tape, a solid state drive (SSD), a RAM drive, a secure digital card or drive, any other suitable storage medium, or any suitable combination of two or more of them. The storage medium, where appropriate, may be volatile, non-volatile, or a combination of volatile and non-volatile. Note that the storage medium is not limited to the examples, and any device or medium may be used as long as it can store the program P.

The server 10 and/or the terminal 20 read the program P stored in the storage medium and execute the read program P to embody the functions of the plural functional units illustrated in the embodiments, for example. However, the server 10 and/or the terminal 20 are not limited to the example.

Further, the program P of the present disclosure may be provided to the server 10 and/or the terminal 20 via any transmission medium (such as a communication network and a broadcast wave) capable of transmitting the program. The server 10 and/or the terminal 20 embody the functions of the plural functional units illustrated in the embodiments by executing the program P downloaded via the Internet, for example. However, the server 10 and/or the terminal 20 are not limited to the example.

The embodiments of the present disclosure may also be embodied in the form of a data signal embedded in a carrier wave in which the program P is embodied through electronic transmission. At least a part of the processing in the server 10 and/or the terminal 20 may be embodied by cloud computing configured by one or more computers. The system may be configured such that at least a part of the processing in the terminal 20 may be performed by the server 10. In this case, the system may be configured such that at least a part of the processing of the functional units of the control device 21 of the terminal 20 may be performed by the server 10. The system may be configured such that at least a part of the processing in the server 10 may be performed by the terminal 20. In this case, the system may be configured such that at least a part of the processing of the functional units of the control device 11 of the server 10 may be performed by the terminal 20. Unless explicitly mentioned, the configuration of the determination in the embodiments of the present disclosure is not indispensable, and predetermined processing is performed if the determination condition is satisfied, or predetermined processing is performed if the determination condition is not satisfied.

Note that the program of the present disclosure may be installed using a script language such as ActionScript and JavaScript (registered trademark), an object-oriented programming language such as Objective-C and Java (registered trademark), and a markup language such as HTML5, for example. However, the program is not limited thereto.

### One Embodiment of the Present Disclosure

In one embodiment of the present disclosure, in the case where the electronic ticket is used, the usage status of the electronic ticket is not updated in the terminal, the display form is changed such that the usage status of the electronic ticket is changed from unused to used, and the usage status as a usage history of the electronic ticket is updated from unused to used in the server. According to the present embodiment, since the entry operation in the terminal and the update of the usage status of the electronic ticket can be executed separately, even in a poor communication environment, the user that uses the terminal is allowed to execute the entry operation without causing inconvenience to the user.

For the sake of illustration, the usage status of the electronic ticket on the display of the terminal is referred to as an operation status and the status is expressed as unoperated and/or operated.

Also, the actual usage status of the electronic ticket in the server is referred to as the usage status, and the status is expressed as unused and/or used. Since the server updates the usage status as will be described later, the usage status is not updated in the terminal and the operation status is changed by the change of the display to provide the user with the UI/UX to show the user as if the electronic ticket has been used.

<Functional Configurations>

(1) Functional Configuration of Terminal

As shown in FIG. 1, the terminal 20 (terminals 20A to 20C) has an acquisition processor 210, a display processor 211, an acceptance processor 212, and a transmission processor 213 as functions embodied by the control device 21.

The acquisition processor 210 has a function of acquiring ticket data from the server 10. The acquisition processor 210 acquires the ticket data from the server 10 at a predetermined timing. The predetermined timing may correspond to, for example but not limited to, a timing at which the ticket data is associated with the user, such as the time when the user of the terminal 20 purchases the ticket. Also, the predetermined timing may correspond to the predetermined timing of distribution of the ticket, and the date and time before the predetermined number of days and the date and time before the predetermined time period from the performance date. Also, the predetermined timing may correspond to the timing at which the terminal 20 requests the server 10 to transmit the ticket data. Note that the predetermined timing is not limited to the examples above, and may be any timing, or a combination of the timings.

The ticket data corresponds to data on an admission ticket (ticket) of the event. The ticket data includes information on the event, such as the title and cast of the event, the date and time of holding the event and the place of holding the event. The ticket data also includes information on the seat such as the type and position of the seat.

The ticket data may include image data for displaying the electronic ticket associated with the ticket data on the display device 24 of the terminal 20.

The display processor 211 includes a function of displaying the electronic ticket corresponding to each of the plurality of ticket data associated with the user of the terminal 20 on the display device 24. The display processor 211 also includes a function of displaying the electronic ticket on the display device 24 in a display form capable of identifying that the electronic ticket associated with the acquired ticket data is unoperated. The display processor 211 also includes a function of displaying the electronic ticket on the display device 24 in a display form capable of identifying that the electronic ticket has already been operated. In the following description, in order to simplify the description, the display form capable of identifying that the electronic ticket is unoperated is referred to as “unoperated display,” and the display form capable of identifying that the electronic ticket has already been operated is referred to as “operated display.”

The display processor 211 displays the electronic ticket in the operated display in response to accepting an operation for changing the status of the electronic ticket from the unoperated display to the operated display. The event staff checks the electronic ticket in the operated display and allows the user that has shown the electronic ticket to enter the event. In this manner, since the electronic ticket is displayed in the operated display in response to accepting the predetermined operation by the display processor 211, the entrance processing can be performed even in the poor communication environment of the terminal that has downloaded the ticket data.

In addition, in the case where the display processor 211 has displayed the electronic ticket in the operated display, if the display processor 211 does not accept a predetermined operation, the display processor 211 does not display the electronic ticket in the unoperated display. After the operated display is displayed, the display processor 211 is controlled to fail to display the unoperated display if the display processor 211 fails to accept a predetermined operation. This prevents fraudulent behavior of a malicious user. In order to simplify the description below, the predetermined operation is referred to as a staff operation.

The predetermined operation is to perform a predetermined operation on the screen of the display device 24 of the terminal 20. The predetermined operation is, for example but not limited to, performing a swipe operation on the screen of the display device 24 of the terminal 20 in accordance with a predetermined trajectory, or performing a predetermined character input, or performing an input of a predetermined code or password. Further, the predetermined operation need not be an operation on the screen of the display device 24 of the terminal 20, but may be a predetermined voice input, for example. Further, the predetermined operation may be different for each event, for each ticket type, or for each date on which the event is held.

As described above, in the case where the display processor 211 has displayed the electronic ticket in the operated display, if the display processor 211 does not accept a predetermined operation, the display processor 211 does not display the electronic ticket in the unoperated display. In this manner, the electronic ticket displayed in the operated display cannot be changed to the unoperated display by anyone except a person that perceives the predetermined operation (for example but not limited to an event organizer or an event staff). This can prevent unauthorized use of the electronic ticket by a malicious user, for example. Accordingly, even if the electronic ticket is set to be in the operated state by, for example, an erroneous operation by the user, another user (for example, the event staff) performs the predetermined operation to prevent the user from performing a dishonest action and deal with the erroneous operation simultaneously.

<Predetermined Condition for Allowing Operation to Change Operation Status of Ticket Data>

If the predetermined condition corresponding to ticket data is satisfied, the acceptance processor 212 allows the terminal 20 to accept an operation for changing the operation status of the ticket data.

The acceptance processor 212 allows the terminal 20 to accept an operation for changing the operation status of the ticket data within a predetermined time period in accordance with the ticket data. The predetermined time period in accordance with the ticket data corresponds to the time set on the basis of the time associated with the ticket data (for example but not limited to the time at which the venue opens or opening time), and the time optionally set. The predetermined time period may correspond to, for example but not limited to, time after the venue of the event associated with the electronic ticket opens and before the opening time, and the time after the venue of the event associated with the electronic ticket opens.

In addition, the acceptance processor 212 may allow the terminal 20 to accept an operation for changing the operation status of the ticket data when the terminal 20 exists within a predetermined distance corresponding to the ticket data. The predetermined distance corresponding to the ticket data may be a case where the terminal 20 approaches the vicinity of the venue of the event associated with the electronic ticket. The vicinity of the venue of the event is within a predetermined distance from the venue of the event or the entrance to the venue of the event. The predetermined distance can be optionally set to any distance such as, but not limited to, 1 km, 100 m, and 10 m. The acceptance processor 212 of the terminal 20 can determine whether or not the terminal 20 approaches the venue of the event associated with the electronic ticket by, for example but not limited to, GPS. The display processor 211 allows the terminal 20 to accept an operation for changing the operation status of the ticket data if it determines that the terminal 20 is located within a predetermined distance from the venue of the event or the entrance to the venue of the event. In contrast, the acceptance processor 212 does not allow the terminal 20 to accept the operation for changing the operation status of ticket data if it does not determine that the terminal 20 is located within a predetermined distance from the venue of the event or the entrance to the venue of the event.

In addition, if the terminal 20 receives a predetermined signal corresponding to the ticket data, the acceptance processor 212 may allow the terminal 20 to accept the operation for changing the operation status of the ticket data. The terminal 20 receives a predetermined signal corresponding to the ticket data from, for example but not limited to, the server 10 or an optional device (not shown) provided in the vicinity of the entrance of the venue of the event.

The predetermined conditions above may be combined. If the predetermined time period and the acquisition of the predetermined signal are combined, the predetermined time period in accordance with the ticket data may be set on the basis of, for example but not limited to, the time in which it is determined that the terminal 20 is located within the predetermined distance for allowing the terminal 20 to accept the operation for changing the operation status of the ticket data, and the time in which the terminal 20 receives a request signal for allowing the terminal 20 to accept the operation for changing the operation status of the ticket data.

As described above, if the predetermined condition in accordance with the ticket data is not satisfied, the operation status of the ticket data cannot be accepted, so that the operation status of the electronic ticket can be prevented from changing from the unoperated state to the operated state by the erroneous operation. In the following description, in order to simplify the description, a predetermined condition will be described as a predetermined time period.

The transmission processor 213 transmits a usage status change request for changing the usage status of the ticket data corresponding to the electronic ticket to the server 10 in response to accepting the predetermined operation for changing the operation status of the electronic ticket to the operated state. The transmission processor 213 may transmit a usage status change request of ticket data corresponding to the electronic ticket in response to displaying the electronic ticket in the operated display. As described above, since the transmission processor 213 transmits the usage status change request of the ticket data corresponding to the electronic ticket to the server 10, the server 10 is allowed to centrally manage the usage status data, preventing the user of the terminal 20 from tampering with the usage status data.

The transmission processor 213 may retry the transmission of the usage status change request a predetermined number of times if the usage status change request cannot be transmitted. Further, if the transmission processor 213 cannot transmit the usage status change request, the transmission processor 213 may retry the transmission of the usage status change request at predetermined time intervals. Further, if the transmission processor 213 cannot transmit the usage status change request, the transmission processor 213 may retry the transmission of the usage status change request a predetermined number of times at predetermined time intervals.

The transmission processor 213 may determine whether or not communication is possible before transmitting the usage status change request. The transmission processor 213 may transmit the usage status change request in response to determining that the communication is possible. The transmission processor 213 does not transmit the usage status change request in response to determining that the communication is impossible. The transmission processor 213 may retry to determine whether or not the communication is possible for a predetermined number of times in response to determining that the communication is impossible. The transmission processor 213 may retry to determine whether or not the communication is possible at predetermined time intervals in response to determining that the communication is impossible. The transmission processor 213 may retry to determine whether or not the communication is possible a predetermined number of times in response to determining that the communication is impossible.

The transmission processor 213 may transmit information on retrying transmission of the usage status change request in addition to the usage status change request o the server 10. The transmission processor 213 may transmit the number of times of retrying the transmission of the usage status change request and the retry time to the server 10. The transmission processor 213 may transmit the number of times of retrying the determination as to whether the communication is possible and the retry time to the server 10.

As described above, since the transmission processor 213 retries the transmission of the usage status change request if it cannot transmit the usage status change request, the transmission processor 213 can recognize the communication environment in the vicinity of the venue in which the event is held by aggregating the number of times of retry and the time. Specifically, from the situation of the retry of the usage status change request in the plurality of terminals 20, the number of the terminals 20 for which the communication environment has not been established and the time period during which the communication environment has not been established are counted so as to recognize the venue of the event in which the communication environment is restricted. This allows the organizers and holders of the event to consider improving the communication environment of the venue of the event, or select an appropriate venue.

(2) Screen Displayed on the Display Device 24 of the Terminal

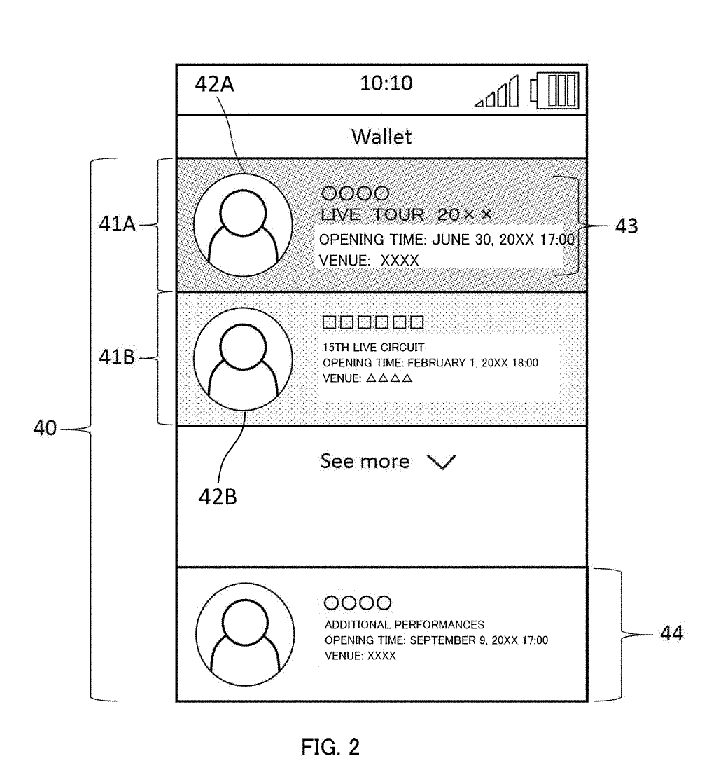

With reference to FIGS. 2 to 6, a screen displayed on the terminal 20 by the display processor 211 will be described.

FIG. 2 is a diagram illustrating a list of electronic tickets displayed on the display device 24 of the terminal 20. As shown in FIG. 2, an electronic ticket list 40, which is a list of electronic tickets each corresponding to one of a plurality of ticket data associated with a user of the terminal 20, is displayed on the display device 24 of the terminal 20. The plurality of ticket data associated with the user of the terminal 20 corresponds to a plurality of ticket data purchased or acquired by the user.

As shown in FIG. 2, the electronic ticket list 40 displays information 41 on a plurality of electronic tickets. The electronic ticket list 40 includes information 41A on the first electronic ticket associated with the first event and information 41B on the second electronic ticket associated with the second event. The information 41A on the first electronic ticket and the information 41B on the second electronic ticket have different display forms. As shown in FIG. 2, the information 41A on the first electronic ticket and the information 41B on the second electronic ticket have different backgrounds for the display forms. If there is one ticket data associated with the terminal 20, the electronic ticket corresponding to the one ticket data is displayed.

Each piece of information 41 on the electronic ticket included in the electronic ticket list 40 may include an object 42 related to the event, such as a photograph of a performer appeared in the event and an icon of the event. As shown in FIG. 2, the object 42A included in the information 41A on the first electronic ticket and the object 42B included in the information 41B on the second electronic ticket have different display forms. This allows the user of the terminal 20 to identify the information 41 related to the plurality of electronic tickets included in the electronic ticket list 40 as information 41 different from each other. In addition, information associated with a friend that shares the event may be displayed (not shown) in association with each piece of the information 41 on the electronic ticket included in the electronic ticket list 40. The information associated with a friend that shares the event refers to, for example but not limited to, information on a friend that transmits the information of the event, a friend that distributes the electronic ticket of the event, or a friend that has an electronic ticket of the event, and is typically the icon of the friend.

In addition, each piece of the information 41 related to the electronic ticket included in the electronic ticket list 40 may include various types of information on the event as text data 43. As shown in FIG. 2, the text data 43 may include information on the event, such as the title and cast of the event, the date and time of the event, and the location of the event. Each piece of the information on the electronic ticket included in the electronic ticket list 40 may include information that allows the user of the terminal 20 to identify each of the plurality of electronic tickets from each other. This allows the user of the terminal 20 to identify the information 41 related to the plurality of electronic tickets included in the electronic ticket list 40 as information 41 different from each other.

As shown in FIG. 2, the electronic ticket list 40 may include the recommendation information 44 for the user of the terminal 20. The recommendation information 44 corresponds to information on events recommended to the user of the terminal 20. The recommendation information 44 may be determined on the basis of the electronic ticket included in the electronic ticket list, the purchase history of the electronic ticket purchased by the user of the terminal 20 in the past, and the position information of the terminal 20, for example. The recommendation information 44 may be information on another event in the case where the performer of the event of the electronic ticket included in the electronic ticket list 40 appears in the other event. Also, the recommendation information 44 may be information on an event of the same type (an event of another orchestra) as an event of an electronic ticket included in the electronic ticket list 40 (an event of an orchestra). This allows the user of the terminal 20 to be recommended an event that the user is likely to be interested in and prompts the user to purchase a new electronic ticket.

The user of the terminal 20 can select each piece of the information 41 of the electronic ticket included in the electronic ticket list 40 shown in FIG. 2 via the input and output device 23. When the user of the terminal 20 selects the information 41 of the electronic ticket included in the electronic ticket list 40, the display device 24 of the terminal 20 displays an electronic ticket corresponding to the information 41 of the selected electronic ticket.

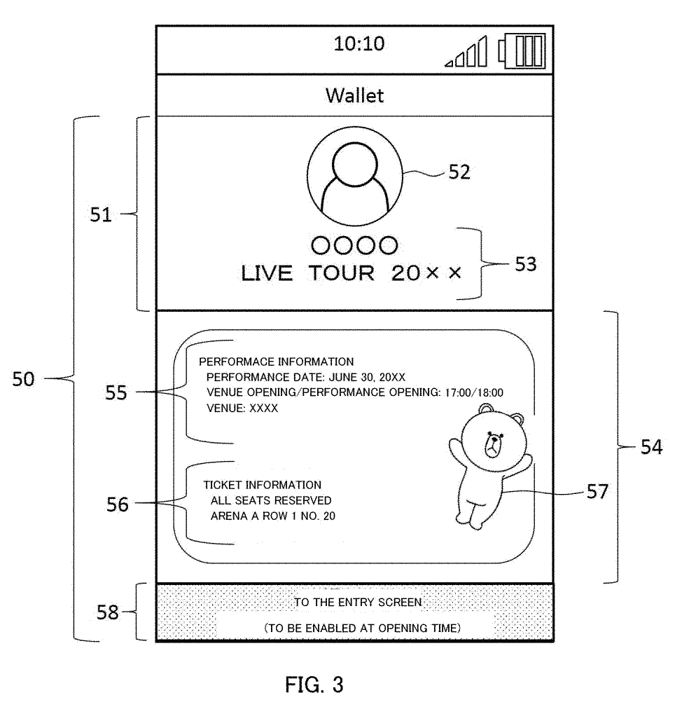

FIG. 3 is a diagram illustrating an example of the electronic ticket displayed on the display device 24 of the terminal 20. As shown in FIG. 3, the display device 24 of the terminal 20 displays an electronic ticket 50. The electronic ticket 50 shown in FIG. 3 is displayed when the user of the terminal 20 selects the information 41 on the electronic ticket included in the electronic ticket list 40. Note that the electronic ticket 50 shown in FIG. 3 is an example in the case where the electronic ticket 50 is displayed in the unoperated display.

As shown in FIG. 3, the electronic ticket 50 includes a region 51 including an event title and an icon of a performer. The region 51 of the electronic ticket 50 may include an object 52 related to the event, such as a photograph of a performer appeared in the event or an icon of the event. Also, the region 51 of the electronic ticket 50 may include text data 53 such as a title of the event. In the electronic ticket 50 shown in FIG. 3, “LIVE TOUR 20XX” is displayed as the text data 53. This allows the user of the terminal 20 to recognize the information on the event associated with the electronic ticket 50. The region 51 of the electronic ticket 50 is not limited to the pieces of information, and may include other information that allows the user of the terminal 20 to distinguish the electronic ticket 50 from other electronic tickets.

As shown in FIG. 3, the electronic ticket 50 includes a region 54 that displays information on the event and the seat. The region 54 of the electronic ticket 50 may include event information 55 which is detailed information on the event, such as the date and time and the place of the event. In the electronic ticket 50 shown in FIG. 3, “performance date: June 30th 20XX”, “venue opening/performance opening: 17:00/18:00,” and “venue: XXXX” are displayed as the event information 55. Also, the region 54 of the electronic ticket 50 may include seat information 56 related to the seat associated with the electronic ticket 50. In the electronic ticket 50 shown in FIG. 3, “All Seats Reserved” and “Arena A Row 1 No. 20” are displayed as the seat information 56. This allows the user of the terminal 20 to recognize the information on the event associated with the electronic ticket 50 and the seat information.

As shown in FIG. 3, the electronic ticket 50 includes a predetermined object 57. The predetermined object 57 may include any data such as a predetermined illustration, a predetermined icon, a predetermined animation, and a predetermined moving image, for example. Further, the predetermined object 57 need not be a predetermined illustration and a predetermined icon, for example, and may be a background of the electronic ticket 50. Further, the predetermined object 57 may be either static or dynamic.

If the predetermined object 57 is dynamic, the display form of the predetermined object 57 is changed at predetermined intervals or random. The predetermined object 57 is displayed in a display form in which the object 57 rotates at predetermined intervals or random at a displayed position, for example, but is not limited to the form. Further, if the predetermined object 57 is dynamic, the display form of a part of the predetermined object 57 may be changed at predetermined intervals or random. The predetermined object 57 may be displayed in a display form in which the predetermined object 57 performs a specific operation (any operation such as laughing, crying, talking, and stepping on) at predetermined intervals or random at a displayed position, for example, but is not limited to the form.

Also, in the predetermined object 57, the display position of the predetermined object 57 in the electronic ticket 50 may be changed at predetermined intervals or random. In FIG. 3, the predetermined object 57 is located at the lower right of the electronic ticket 50. However, it may be displayed at other places of the electronic ticket 50 at predetermined intervals or random. The predetermined object 57 may move from one display position to another display position at predetermined intervals or random. Further, the predetermined object 57 itself may be changed at predetermined intervals or random. In FIG. 3, the predetermined object 57 is an illustration imitating “bear”, but it may be changed to another illustration such as “cat.”

Further, the predetermined object 57 may be a background. If the predetermined object 57 is dynamic, the background of the electronic ticket 50 changes at predetermined intervals or random. If the predetermined object 57 is a background, the color and mode of the background may change at predetermined intervals or random. Note that the predetermined object 57 need not be the entire background of the electronic ticket 50 but may be a part of the background. If the predetermined object 57 is a part of the background, the color and mode of the part of the background changes at predetermined intervals or random.

As described above, since the electronic ticket 50 includes the predetermined object 57, it is difficult for the user of the terminal 20 to tamper with or duplicate the electronic ticket 50, preventing unauthorized use of the electronic ticket 50. If the predetermined object 57 is a dynamic object, by checking whether or not the predetermined object 57 changes at predetermined intervals or random, it is determined whether the electronic ticket 50 has been tampered or duplicated, preventing the unauthorized use of the electronic ticket 50. Further, the predetermined object 57 is dynamically displayed in response to an operation from the user so as to determine whether or not the screen on which the predetermined object 57 is displayed is recorded.

Further, the predetermined object 57 may be different for each electronic ticket 50. The predetermined object 57 for the first electronic ticket 50A associated with the first event and the predetermined object 57 for the second electronic ticket 50B associated with the second event to be displayed may be different from each other. This allows the user of the terminal 20 to identify each of the electronic tickets 50 displayed on the display device 24 of the terminal 20 from each other. Since the predetermined object 57 is different for each electronic ticket 50, in order to tamper with or duplicate the electronic ticket 50, it need to tamper with or duplicate each electronic ticket 50, requiring time and efforts so as to prevent the unauthorized use of the electronic ticket 50.

As shown in FIG. 3, the electronic ticket 50 includes a region 58 for changing the screen to the entry screen. The region 58 can be selected by the user of the terminal 20 via the input and output device 23 within a predetermined time period according to the ticket data. Specifically, the acceptance processor 212 allows the user to select the region 58 for changing the screen to the entry screen within a predetermined time period according to the ticket data. When the region 58 becomes active, the user of the terminal 20 can select the region 58 via the input and output device 23. In response to the operation by the user, the display changes from the screen on which the electronic ticket 50 in the unoperated display is displayed to the entry screen.

As described above, since the user of the terminal 20 is allowed to select the region 58 of the electronic ticket 50 via the input and output device 23 within a predetermined time period according to the ticket data, the region 58 allows the user to change the screen to the entry screen at the time when the event is close to be opened, preventing the screen from changing to the entry screen due to malfunction at the timing irrelevant to the holding of the event.

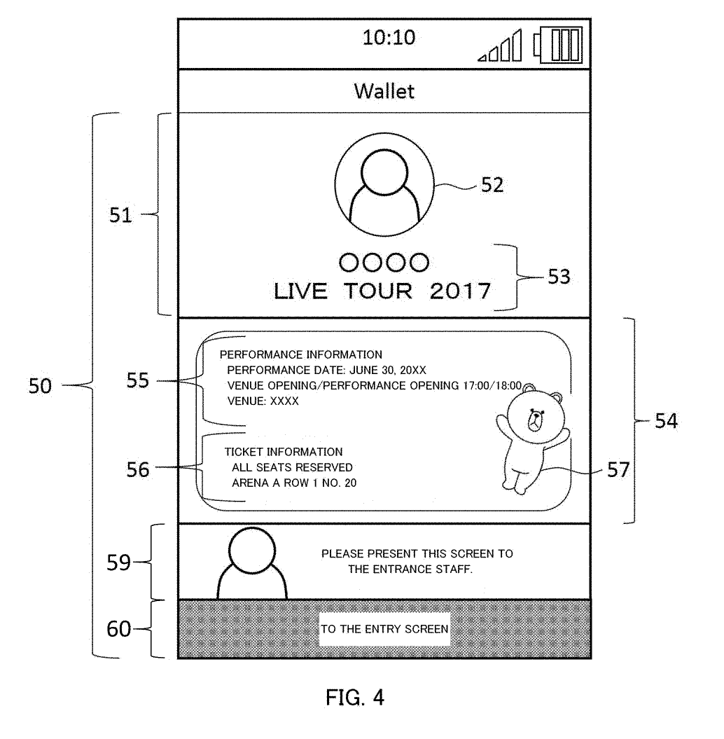

FIG. 4 is a diagram illustrating another example of the electronic ticket 50 displayed on the display device 24 of the terminal 20. FIG. 4 shows an example of the electronic ticket 50 displayed on the display device 24 of the terminal 20 when the region 58 for changing the screen to the entry screen of the electronic ticket 50 is selected. As shown in FIG. 4, in the electronic ticket 50, a region 59 on which text data is displayed and a region 60 for changing the screen to an operation screen for accepting a predetermined operation are displayed. Note that the region 51 and the region 54 of the electronic ticket 50 shown in FIG. 4 are the same as the region 51 and the region 54 shown in FIG. 3, and thus detailed description thereof will be omitted.

As shown in FIG. 4, the region 59 on which the text data is displayed includes the character string “Please present this screen to the entrance staff” as text data. This can prompt the user of the terminal 20 to present the electronic ticket 50 to the entrance staff in the venue of the event.

Further, as shown in FIG. 4, the user is allowed to select the region 60 for changing the screen to the operation screen via the input and output device 23 of the terminal 20. For the region 60 for changing the screen to the operation screen, a character string “enter the entry screen” may be displayed. The region 60 for changing the screen to the operation screen may be selectable at any time via the input and output device 23 after being displayed or may be selectable only within a predetermined time period according to the ticket data. More specifically, the acceptance processor 212 allows the user to select the region 60 for changing the screen to the operation screen within a predetermined time period according to the ticket data. When the region 60 for changing the screen to the operation screen becomes active, the user of the terminal 20 is allowed to select the region 60 for changing the screen to the operation screen via the input and output device 23.

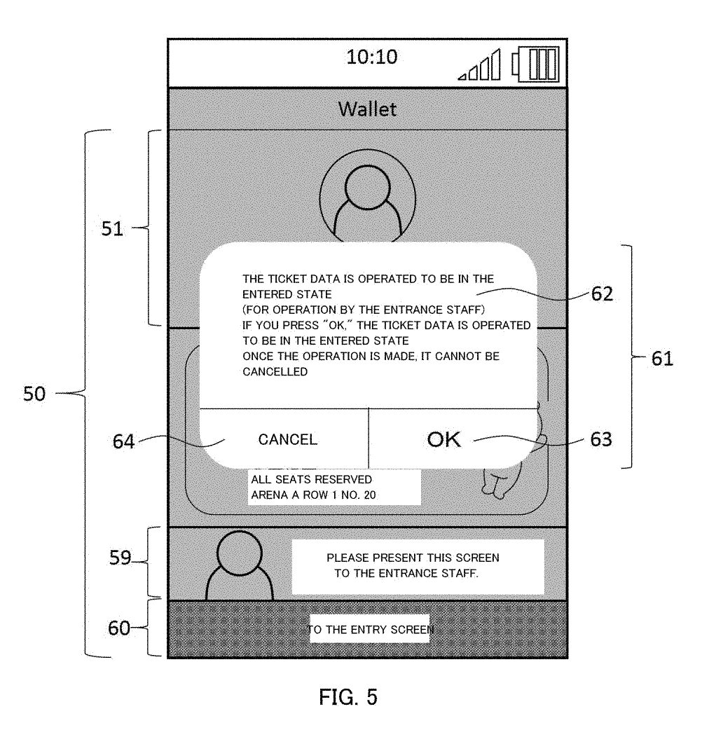

FIG. 5 is a diagram illustrating another example of the electronic ticket 50 displayed on the display device 24 of the terminal 20. FIG. 5 is an example of the electronic ticket 50 displayed on the display device 24 of the terminal 20 when the region 60 for changing the screen is selected. As shown in FIG. 5, on the electronic ticket 50, an operation screen 61 for accepting a predetermined operation is displayed. Note that the other regions of the electronic ticket 50 are the same as the other regions shown in FIG. 3 and FIG. 4, and thus detailed description thereof will be omitted.

As shown in FIG. 5, the operation screen 61 includes text data 62, a region 63 to be selected in the case of performing an operation to change the electronic ticket 50 from the unoperated display to the operated display, and a region 64 to be selected in the case of cancellation. As shown in FIG. 5, the operation screen 61 is displayed in the display form superimposed on the electronic ticket 50. Note that the operation screen 61 is not limited to the superimposed display form, but may be displayed as a part of the region of the electronic ticket 50 or only the operation screen 61 may be displayed.

As shown in FIG. 5, the operation screen 61 includes a region 63 to be selected in the case of performing an operation to change the status of the electronic ticket 50 to be used. On the region 63, the character string “OK” may be displayed. The region 63 can be selected via the input and output device 23 of the terminal 20. In response to the selection of the region 63, the status of the electronic ticket 50 changes to the operated display.

As shown in FIG. 5, the operation screen 61 may include a region 64 to be selected in the case of performing an operation to cancel. On the region 64, the character string “CANCEL” may be displayed. In response to the selection of the region 64, the display device 24 of the terminal 20 may change the display of the operation screen 61 to a screen for selecting a change of the screen to the operation screen shown in FIG. 4. Further, in response to the selection of the region 64, the display device 24 of the terminal 20 may change the display to a screen for changing the screen to the entry screen shown in FIG. 3.

As shown in FIG. 5, the operation screen 61 includes, as text data 62, character strings “The ticket data is operated to be in the entered state (for operation by the entrance staff) If you press “OK,” the ticket data is operated to be in the entered state. Once the operation is made, it cannot be cancelled.” The character string “for operation by the entrance staff” allows the user of the terminal 20 to recognize that the operation screen 61 corresponds to the operation screen for the operation by the entrance staff in the venue of the event.

Further, the character string “Once the operation is made, it cannot be cancelled” notifies the user of the fact that the change of the screen cannot be cancelled after the electronic ticket 50 is displayed as in the operated state. This can prevent the electronic ticket 50 from changing to the operated display due to an erroneous operation by the user of the terminal 20, for example.

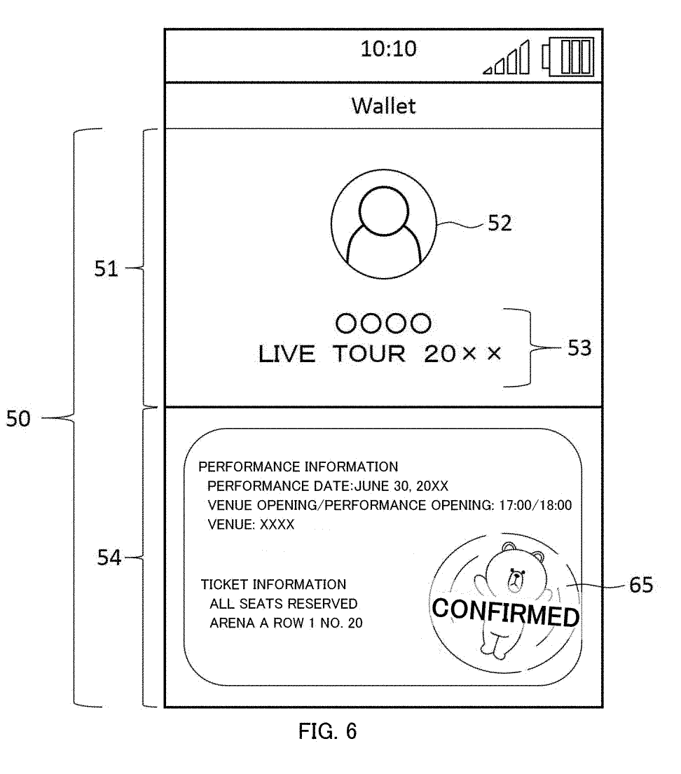

FIG. 6 is a diagram illustrating another example of the electronic ticket 50 displayed on the display device 24 of the terminal 20. FIG. 6 is a screen displayed in response to the selection of the region 63 of the operation screen 61 shown in FIG. 5. The electronic ticket 50 shown in FIG. 6 corresponds to the electronic ticket 50 displayed in the operated display.

As shown in FIG. 6, the electronic ticket 50 that has been displayed as being operated includes a predetermined object 65 to which the character “CONFIRMED” is attached. Note that the region 51 and the region 54 of the electronic ticket 50 shown in FIG. 6 are the same as the region 51 and the region 54 shown in FIG. 3, and thus detailed description thereof will be omitted.

As shown in FIG. 6, the electronic ticket 50 includes a predetermined object 65 to which the character string “CONFIRMED” is attached. As described above, the electronic ticket 50 includes the predetermined object 65 to which the character string “CONFIRMED” is attached so that it is displayed in the operated display. The characters included in the predetermined object 65 may be any characters as long as it is possible to identify that the electronic ticket 50 has been operated. It should be noted that the predetermined object 65 need not include a character string as long as it can be identified that the electronic ticket 50 has been operated.

The predetermined object 65 may include any data such as a predetermined illustration and a predetermined icon. Further, the predetermined object 65 need not be a predetermined illustration and a predetermined icon, and may be a background of the electronic ticket 50. Further, the predetermined object 65 may be static or dynamic. Note that the predetermined object 65 is the same as the predetermined object 57 shown in FIG. 3 except that the character string “CONFIRMED” is attached, so that the detailed description thereof will be omitted.

As described above, since the electronic ticket 50 includes the predetermined object 65 to which the character string “CONFIRMED” is attached so that it is displayed in the operated display, allowing the user of the terminal 20 and the entrance staff to recognize that the electronic ticket 50 has been operated.

(3) Functional Configuration of the Server

As shown in FIG. 1, the server 10 includes a transmission processor 110 and a reception processor 111 as functions embodied by the control device 11.

The transmission processor 110 includes a function of transmitting ticket data to the terminal 20. The transmission processor 110 transmits ticket data to the terminal 20 at a predetermined timing. The predetermined timing corresponds to, for example but not limited to, the timing in which the ticket data is associated with the user, such as the time in which the user of the terminal 20 purchases the ticket. Also, the predetermined timing may be the predetermined timing of distribution of the tickets or the date and time before the predetermined number of days from the performance date and time. Also, the predetermined timing may correspond to a timing in which a transmission request for ticket data is received from the terminal 20. Note that the predetermined timing is not limited to the examples above, and may be any timing.

Further, the transmission processor 110 may transmit to the terminal 20 a signal permitting acceptance of an operation for changing the operation status of the electronic ticket 50. The transmission processor 110 may transmit to a plurality of the terminals 20 to which a plurality of the corresponding electronic tickets 50 associated with a specific event have been downloaded a signal permitting acceptance of an operation for changing the operation status of the electronic ticket 50 at a time. Moreover, the transmission processor 110 may transmit a signal permitting acceptance of an operation for changing the operation status of the electronic ticket 50 in response to a request from the terminal 20.

The reception processor 111 receives from the terminal 20 a status change request of ticket data corresponding to the electronic ticket. In response to receiving the usage status change request, the reception processor 111 changes the status information included in the information on the ticket data stored in the storage device 15 from “unused” to “used.”

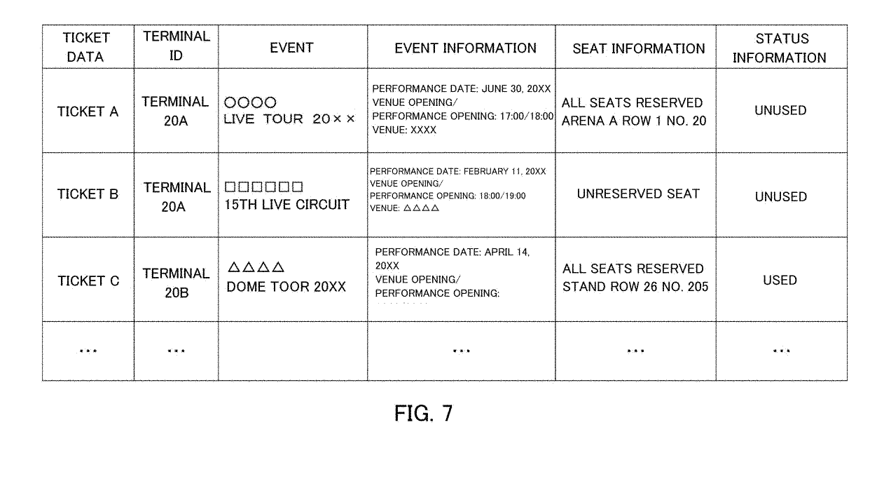

FIG. 7 shows information on ticket data stored in the storage device 15 of the server 10. As shown in FIG. 7, the information on the ticket data includes a terminal ID that can uniquely identify the terminal 20 that downloads the ticket data. Further, the information on the ticket data includes information on the event corresponding to the ticket data, such as the title and cast of the event corresponding to the ticket data, and the date and time and place of the event. Moreover, the information on the ticket data includes information on the seat such as the type and position of the seat. Furthermore, the information on the ticket data includes information on the usage status of the ticket data. The information on the usage status is “unused” or “used.” The information on the ticket data may include the time in which the usage status change request is received and the number of times the terminal 20 retries the transmission of the usage status change request (not shown).

In response to receiving the usage status change request of ticket data from the terminal 20, the reception processor 111 changes the usage status information stored in the storage device 15 of the server 10 from “unused” to “used.” Specifically, in response to receiving the usage status change request of ticket data from the terminal 20, the usage status information of “ticket A” is changed from “unused” to “used.”

As described above, since the server 10 changes the usage status of the ticket data corresponding to the electronic ticket in response to the usage status change request from the terminal 20A, the usage status of the ticket data is centrally managed by the server 10, preventing the user of the terminal 20 from tampering with the usage status data.

<Operation Example>

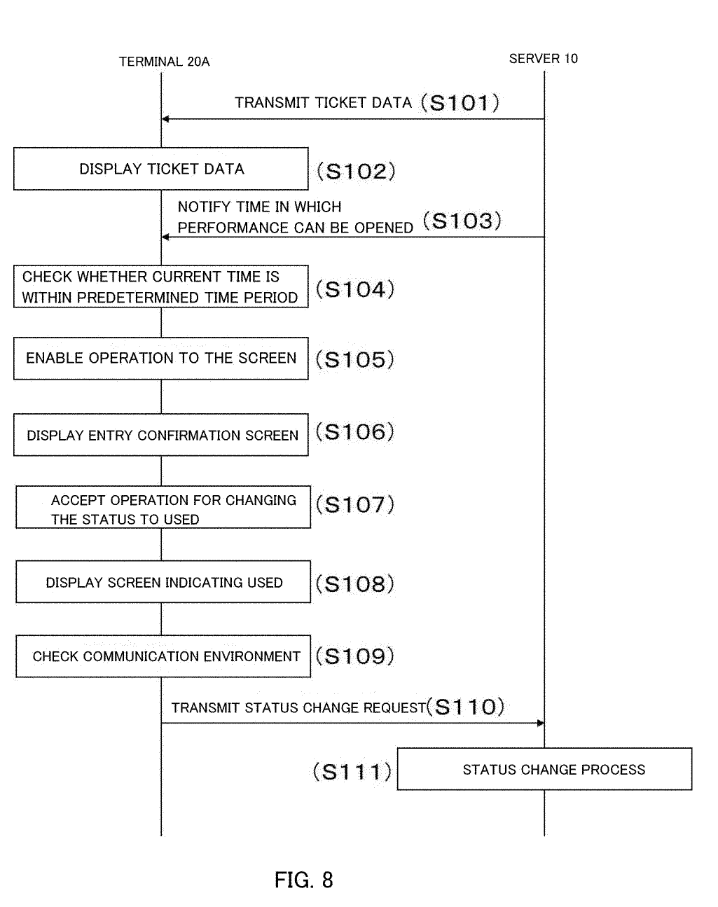

FIG. 8 is a sequence diagram showing an operation example of the communication system according to an embodiment of the present disclosure.

As shown in FIG. 8, the transmission processor 110 of the server 10 transmits ticket data to the terminal 20 at a predetermined timing (step S101).

On the basis of the received ticket data, the display processor 211 of the terminal 20 causes the display device 24 to display an electronic ticket associated with the ticket data on the display device 24 (step S102).

The transmission processor 110 of the server 10 transmits to the terminal 20 a signal permitting acceptance of an operation for changing the operation status of the electronic ticket 50 (step S103).

The acceptance processor 212 of the terminal 20 checks whether the current time is within a predetermined time period according to the ticket data (step S104), and in response to the determination that the time is within the predetermined time period, allows the terminal 20 to accept an operation for changing the operation status of the electronic ticket (step S105).

The display processor 211 of the terminal 20 displays an operation screen 61 (see FIG. 5) for performing an operation for changing the status of the electronic ticket 50 to entered (step S106), and in response to the operation for changing the status of the electronic ticket 50 to entered, displays the electronic ticket 50 in the operated display (step S107).

Before transmitting the usage status change request, the transmission processor 213 of the terminal 20 determines whether or not communication is possible (step S108), and transmits a usage status change request in response to the determination that the transmission is possible (step S109). Note that the transmission processor 213 may retry to determine whether or not communication is possible a predetermined number of times, in response to determining that communication is impossible.

In response to receiving the usage status change request of ticket data corresponding to the electronic ticket from the terminal 20, the reception processor 111 of the server 10 changes the usage status information included in the information on the ticket data stored in the storage device 15 to “used” (step S110).

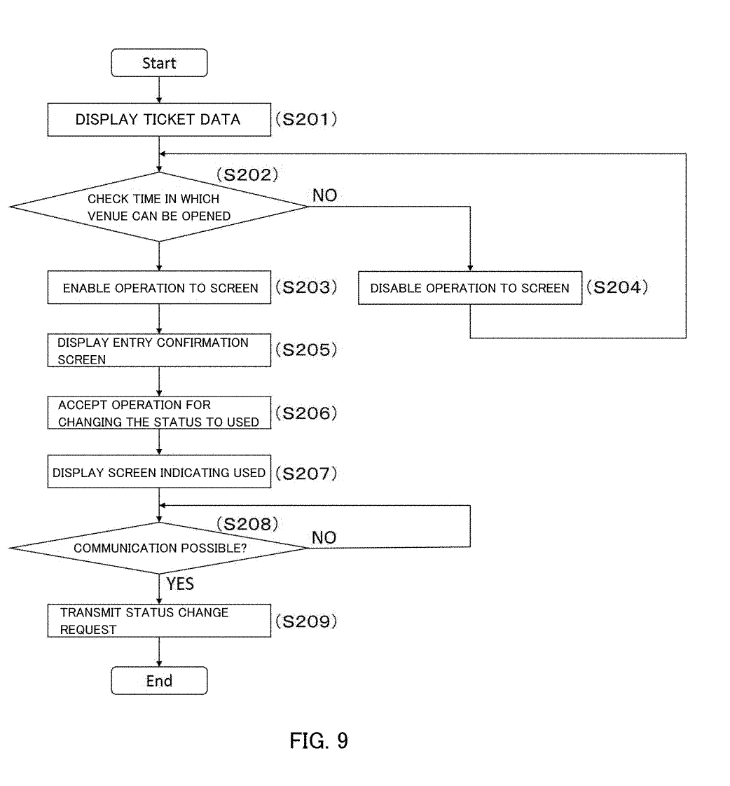

FIG. 9 is a flowchart showing an operation example of the terminal 20 in an embodiment of the present disclosure.

As shown in FIG. 9, the display processor 211 of the terminal 20 causes the display device 24 to display an electronic ticket associated with the ticket data on the display device 24 on the basis of the received ticket data (step S201).

The acceptance processor 212 checks whether a current time is within a predetermined time period according to the ticket data (step S202). In response to determining that the time is within the predetermined time period (YES in step S202), the acceptance processor 212 allows the terminal 20 to accept an operation for changing the operation status of the electronic ticket (step S203). In contrast, in response to determining that it is not within the predetermined time period (NO in step S202), the acceptance processor 212 does not allow the terminal 20 to accept the operation for changing the operation status of the electronic ticket (step S204) and returns to step S202.

The display processor 211 displays an operation screen 61 (see FIG. 5) for performing an operation to change the status of the electronic ticket 50 to entered (step S205). In response to the operation for changing the status of the electronic ticket 50 to entered, the display processor 211 displays the electronic ticket 50 in the operated display (step S206).

Before transmitting a usage status change request, the transmission processor 213 determines whether or not communication is possible (step S207). In response to determination that the transmission is possible (YES in step S207), the transmission processor 213 transmits the usage status change request (step S208). In contrast, in response to determining that communication is impossible (NO in step S207), the transmission processor 213 returns to step S207. Note that the transmission processor 213 may retry to determine whether or not communication is possible a predetermined number of times.

<Advantage in One Embodiment of Present Disclosure>

In the communication system according to an embodiment of the present disclosure, in response to acceptance of a predetermined operation by the terminal 20, the electronic ticket is displayed in the operated display, and a usage status change request of ticket data corresponding to the electronic ticket is transmitted to the server 10. Therefore, in the communication system according to an embodiment of the present disclosure, since the admission processing can be performed even in the poor communication environment for the terminal 20 that has downloaded the ticket data and the usage status change request of the ticket data is transmitted, the usage status data can be centrally managed by the server, preventing tampering with the usage status data and unauthorized use of the electronic ticket. Further, if the terminal 20 cannot transmit the usage status change request, the terminal 20 retries transmitting the status change request. Since the terminal 20 counts the number of retries and time, the communication environment in the vicinity of the venue where the event is held can be recognized. This allows the event organizers and holders to consider improving the communication environment of the venue of the event, or select an appropriate venue.

Although embodiments of the present disclosure have been described on the basis of the drawings and examples, it should be noted that those skilled in the art can easily make various deformations and modifications on the basis of the present disclosure. It is therefore to be noted that the deformations and modifications fall within the scope of the present disclosure. Functions included in means and steps can be rearranged without being logically inconsistent with each other, and the means and steps may be combined to be integrated or divided into a plurality of means and steps, for example. However, the means and step are not limited to this. Further, the configurations described in the embodiments may be appropriately combined.

1. An information processing program causing an information processing terminal to execute the steps of:
acquiring ticket data;
displaying an electronic ticket associated with the ticket data and an operation status showing an operation state of the electronic ticket;
allowing the information processing terminal to receive an operation for changing the operation status of the electronic ticket if a predetermined condition corresponding to the ticket data is satisfied;
allowing the information processing terminal to change the operation status of the electronic ticket to an operated state in response to an operation of a user changing the operation status; and
transmitting a usage status change request for changing a usage status of the ticket data after the operation status of the electronic ticket is changed, wherein
the usage status of the electronic ticket is not changed if the operation status of the electronic ticket is the operated state and the usage status change request is not transmitted.

2. The information processing program according to claim 1, further causing the information processing terminal to execute the step of retrying transmission of the usage status change request at predetermined time intervals if the usage status change request is not transmitted.

3. The information processing program according to claim 1, further causing the information processing terminal to execute the step of retrying transmission of the usage status change request a predetermined number of times if the status change request is not transmitted.

4. The information processing program according to claim 1, wherein the predetermined condition is whether a current time is within a predetermined time period corresponding to the ticket data.

5. The information processing program according to claim 1, further causing the information processing terminal to execute the steps of: determining whether or not communication is possible before transmitting the usage status change request; and transmitting the usage status change request if a result of the determination is in that the communication is possible.

6. The information processing program according to claim 1, further causing the information processing terminal to execute the step of displaying the electronic ticket and an object corresponding to the electronic ticket, wherein
a first object associated with a first electronic ticket corresponding to a first event and a second object associated with a second electronic ticket corresponding to a second event are different from each other.

7. The information processing program according to claim 6, wherein the object includes an object that dynamically changes in response to an operation of the user.

8. The information processing program according to claim 6, wherein the object is a background.

9. The information processing program according to claim 1, further causing the information processing terminal to execute the step of notifying that the change of the operation status cannot be canceled before the operation status of the electronic ticket in the operated state is displayed and after the operation status of the electronic ticket is displayed in an unoperated state.

10. The information processing program according to claim 1, wherein the operation status of the electronic ticket is not allowed to be changed to an unoperated state after the operation status of the electronic ticket is displayed in the operated state.

11. The information processing program according to claim 1, wherein the operation status of the electronic ticket is displayed in an unoperated state in response to acceptance of a predetermined operation after the operation status of the electronic ticket is displayed in the operated state.

12. The information processing program according to claim 11, wherein the predetermined operation is associated with the ticket data in advance.

13. The information processing program according to claim 11, wherein the predetermined operation is one of an operation input to a screen of the information processing terminal, a voice input, and a character input.

14. An information processing method comprising the steps of:
acquiring ticket data;
displaying an electronic ticket associated with the ticket data and an operation status showing an operation state of the electronic ticket;
allowing an acceptance of an operation for changing the operation status of the electronic ticket if a predetermined condition corresponding to the ticket data is satisfied;
changing the operation status of the electronic ticket to an operated state in response to the operation for changing the operation status by the user; and
transmitting a usage status change request for changing a usage status of the ticket data after the operation status of the electronic ticket is changed, wherein
the usage status of the electronic ticket is not changed if the operation status of the electronic ticket is the operated state and the usage status change request is not transmitted.

15. A request information processing terminal, comprising:
an acquiring processor for acquiring ticket data;
a display processor for displaying an electronic ticket associated with the ticket data and an operation status showing an operation state of the electronic ticket;
an acceptance processor for allowing an acceptance of an operation for changing the operation status of the electronic ticket if a predetermined condition corresponding to the ticket data is satisfied; and
a transmission processor for changing the operation status of the electronic ticket to an operated state in response to the operation for changing the operation status by the user, wherein
the transmission processor transmits a usage status change request for changing a usage status of the ticket data after the operation status of the electronic ticket is changed, and
the usage status of the electronic ticket is not changed if the operation status of the electronic ticket is the operated state and the usage status change request is not transmitted.
